(19) United States
(12) Patent Application Publication
(10) Pub. No.: US 2015/0282610 A1
(43) Pub. Date: Oct. 8, 2015

(54) VEHICLE SIMULATOR STATION

(71) Applicant: The Secretary of State for Defence, Salisbury, Wiltshire (GB)

(72) Inventor: Mark Lee Everett, Salisbury (GB)

(21) Appl. No.: 14/438,287

(22) PCT Filed: Oct. 25, 2013
(86) PCT No.: PCT/GB2013/000457

§ 371 Date: Apr. 24, 2015

(30) Foreign Application Priority Data
Oct. 26, 2012 (GB) 1219251.4

(51) Int. Cl. A47B 21/03; G09B 9/042; A47B 21/04

(52) U.S. Cl. CPC A47B 21/0314; A47B 21/04; G09B 9/042; A47B 2021/0364

(57) ABSTRACT

There is provided a vehicle simulator station (1) for resting upon a desktop (10). The vehicle simulator station (1) comprises a central portion (20) for sliding towards an edge (12) of the desktop, and a side portion (40, 45) for sliding from a stowed position adjacent the central portion to an extended position beyond the central portion in the direction (DS) of the sliding of the central portion towards the edge of the desktop.

### TECHNICAL FIELD OF THE INVENTION

The invention relates to a vehicle simulator station, in particular a vehicle simulator station for a desktop.

### BACKGROUND TO THE INVENTION

Vehicle simulator stations are typically used to simulate the use of a vehicle, for example when the actual vehicle itself is not available, or for when an operator wishes to gain practice at using the vehicle.

Vehicle simulator stations can range from very large and complex installations, to a simple control interfaces, such as a joystick. It is desirable to accurately reflect the cockpit and controls of the vehicle, without incurring excessive expense, complexity or taking up excessive space.

The U.S. Pat. No. 5,409,307 describes a desk which may be converted into a vehicle, simulator cockpit by using a complex arrangement of various movable panels and portions. However, the desk needs to be a desk which is specifically designed for such conversion.

There is a need for a vehicle simulator station which can be easily applied to existing desks as and when required, and which is also reconfigurable to facilitate continued use of the desk for other purposes when the simulator station is not required.

It is therefore an aim of the invention to improve upon the known art.

### SUMMARY OF THE INVENTION

According to a first aspect of the invention, there is provided a vehicle simulator station for resting upon a desktop. The vehicle simulator station comprises a central portion for sliding towards an edge of the desktop, and a side portion for transitioning from a stowed position adjacent the central portion to an extended position beyond the central portion in the direction of the sliding of the central portion towards the edge of the desktop.

The use of a slidable central portion means that the central portion can be slid towards the edge of the desktop (and therefore towards a user) when the vehicle simulator station is required, and slid back again when not required so that the user can easily continue with any other work they may be performing upon the desktop. Furthermore, the side portion, which may slide with the central portion, may be transitioned to an extended position even further towards the user than the central portion, enabling an even more realistic representation of a vehicle cockpit to be achieved.

Advantageously, the vehicle simulator station may comprise a base portion for resting upon the desktop, and the central portion may be configured to slide over the base portion to perform the sliding of the central portion towards the edge of the desktop. The provision of the base portion enables the sliding resistance of the central portion and the extent of the sliding of the central portion to be controlled by the interface between the base portion and the central portion.

Furthermore, the base portion may comprise fixing means for fixing the position of the base portion upon the desktop. Then any unwanted movement or overbalancing of the vehicle simulator station is inhibited by the weight of the desktop and the desk supporting the desktop. The fixing means may for example comprise suction cups or clamps for attaching to the desktop. The base portion may comprise rails for the sliding of the central portion over the base portion.

The base portion may support the central portion at least 25 mm above the desktop, such that the sliding of the central portion towards the edge of the desktop can take place without impacting a keyboard positioned on the desktop between the base portion and the edge of the desktop. Accordingly, the user does not need to store any items that may be upon the desktop away before sliding the central portion towards them when they desire to use the vehicle simulator station.

The central portion may comprise a mount or platform for supporting a visual display unit, so that the visual display unit can be used to display data to the user. The displayed data may be unrelated to the vehicle simulator station, for example when the vehicle simulator station is not being used to simulate a vehicle, or the data may relate to the vehicle simulator station, for example the data may provide instrumentation or a view through a vehicle window when the vehicle simulator station is being used to simulate the vehicle. The central portion may comprise a further platform for supporting a further visual display unit to simulate a further part of the visual environment of the cockpit of the simulated vehicle.

Advantageously, the side portion may be supported by the central portion or the base portion, such that the side portion can extend beyond the edge of the desktop in the extended position. Specifically, the side portion may be prevented from over-balancing off the edge of the desktop by virtue of the support provided by the central portion or the base portion. Preferably, the side portion is supported by the central portion since this is typically slid closer to the edge of the desktop than the base portion and therefore provides better support.

The sliding of the side portion from the stowed position into the extended position may comprise moving the side portion from a more upright position in which it takes up less space in the direction of the sliding of the central portion, to a more horizontal position in which it takes up more space in the direction of the sliding of the central portion. Accordingly, the side portion takes up less desktop space in the stowed position than when, it is to be used in the extended position, and the length of the side portion itself does not have to be modified.

The side portion may comprise a simulated vehicle control interface, for example to simulate a control interface that is found within the vehicle to be simulated, such as an aircraft control stick, a gear stick, or a steering wheel.

Preferably, the simulated vehicle control interface is operable to control a simulated vehicle when the side portion is in both the stowed position and the extended position. Then, a user of the vehicle simulator station has a choice as to whether they wish to use the vehicle simulator station with the side portion in the stowed position, or whether they wish to use the vehicle simulator station with the side portion in the extended position.

The use of the vehicle simulator station with the side portion in the stowed position may be advantageous if the user wishes to use a keyboard on the desktop at the same time, for example when the central portion has been slid away from the edge of the desktop. The use of the vehicle simulator station with the side portion in the extended position may be advantageous if the user wishes to more fully simulate the vehicle cockpit, for example when the central portion has been slid towards the edge of the desktop.

The vehicle simulator station may comprise a further side portion for sliding from a stowed position adjacent the central portion to an extended position beyond the central portion in the direction of the sliding of the central portion towards the edge of the desktop. The further side portion may comprise a further simulated vehicle control interface, for example to simulate a further control interface that is found within the vehicle to be simulated. The further control interface and the control interface may be found within the vehicle at a different positions to one another, and the extended positions of the side portion and the further side portion may be set to reflect these different positions.

The vehicle simulator station may be an aircraft simulator station. Advantageously, the simulated vehicle control interface may comprise a throttle control, the further simulated vehicle control interface may comprise a stick control, and the extended positions of the side portion and the further side portion may place the throttle control and stick control in positions simulating their positions in an aircraft.

The vehicle simulator station may further comprise a centre control portion that extends from the central portion in the direction of the sliding of the central portion towards the edge of the desktop. The centre control portion may provide a central simulated vehicle control interface to further facilitate simulation, for example the central simulated vehicle control interface may comprise a steering wheel for a car simulator, or a centre-mounted aircraft stick or yoke.

The centre control portion may attach to the front edge of the central portion, for example by use of a clip or other fastener.

The centre control portion may comprise a first portion configured to extend beyond the edge of the desktop, and a second portion configured to extend beneath the desktop to help counterbalance the weight of the first portion. The central simulated vehicle control interface would then be provided on the first portion.

Preferably, the side portion, and/or the centre control portion, may further comprise an interchangeable module mount configured to secure the simulated vehicle control interface in position when required for use and further configured to release the simulated vehicle control interface from the side portion, and/or the centre control portion, when not required for use. Preferably, the interchangeable module mount may be capable of accommodating a variety of simulated vehicle control interfaces. Therefore, the simulated vehicle control interface could be easily changed to enable to vehicle simulator station to simulate the controls of a wide number of vehicles. For example, when simulating the control interface of an aircraft, the interchangeable module mount would enable the vehicle control interface, such as, but not limited to, a throttle control, a stick control and/or a yoke control to be interchanged with other vehicle control interfaces enabling the vehicle simulator configuration to be reconfigured to simulate more than one type of aircraft. Clearly the use of an interchangeable modular mount would not limit the vehicle simulator to configuration changes to within one class of vehicle. For example, the simulated vehicle control interface of an aircraft could be interchanged with the vehicle control interface of a motor vehicle. The interchangeable module mount comprises a fixing means which may be, for example, a clip, a fabric hook-an-loop fastener, a bolt and nut arrangement or other fastener configured to secure the simulated vehicle control interface in position.

There is further provided an apparatus comprising the vehicle simulator station of the first aspect of the invention, and at least one transportation box. The vehicle simulator station may be configured to be disassembled and stored for transport in the at least one transportation box. Then, the vehicle simulator station can easily be transported from one desktop to another desktop for use at different locations.

Advantageously, the central section may be constructed from plate elements, the plate elements configured to be disconnected from one another and stacked upon one another for compact storage in one of more of the at least one transportation box. This helps reduce the required size of the transportation box(es).

### BRIEF DESCRIPTION OF THE DRAWINGS

Embodiments of the invention will now be described by way of example only and with reference to the accompanying drawings, in which:

FIG. 1 shows a schematic diagram of a vehicle simulator station according to an embodiment of the invention, the vehicle simulator station resting upon a desktop and having a central portion;

FIG. 2 shows a schematic diagram of the vehicle simulator station of FIG. 1, in a position wherein a central portion of the vehicle simulator station has been slid towards an edge of the desktop;

FIG. 3 shows a schematic diagram of the vehicle simulator station of FIG. 1, in a position wherein side portions of the vehicle simulator station have been extended in the direction of the sliding of the central portion towards the edge of the desktop; and

FIG. 4 shows a schematic diagram of two transportation boxes into which the vehicle simulator station of FIG. 1 may be disassembled and stored for transport.

The drawings are for illustrative purposes only and are not to scale.

### DETAILED DESCRIPTION

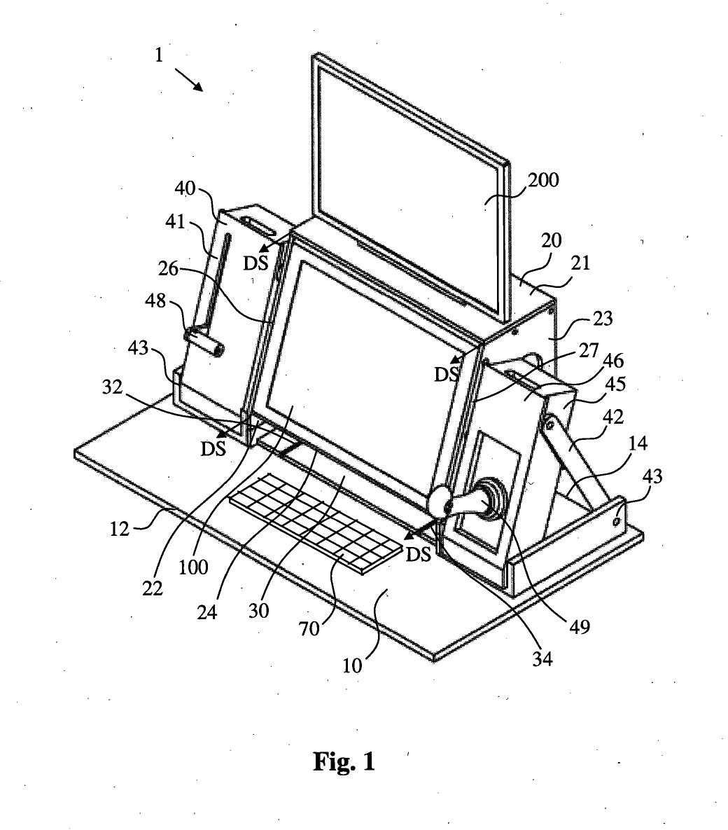

An embodiment of the invention will now be described with reference to the schematic diagram of FIG. 1, which shows a vehicle simulator station 1. The vehicle simulator station 1 is shown resting upon a horizontal desktop 10, and comprises a central portion 20, a base portion 30, and two side portions 40 and 45.

The base portion 30 is a rectangular plate that is secured in position upon the top of the desktop 10 by clamps (not visible in Figs). The clamps clamp the base portion plate 30 to the desktop 10 at a rear edge 14 of the desktop. A protruding flange may be included at the rear of the base portion plate 30 to aid location, or an integral clamp may be fashioned using the rear of the base portion plate 30. In an alternate embodiment, the base portion plate 30 may comprise suction cups to secure itself to the desktop 10, instead of requiring clamps.

The central portion 20 is directly above the base portion plate 30, and comprises a top plate 21, a bottom plate 24, and left and right side plates 22 and 23. The left and right side plates 22 and 23 are both connected to the top plate 21 and bottom plate 24, and space the top plate 21 and the bottom plate 24 apart from one another.

The bottom plate 24 and/or left and right side plates 22 and 23 are fitted with fastenings that locate into two rails 32 and 34 provided on the base portion plate 30. The fastenings control and limit forward and aft movement of the central portion 20 in relation to the base portion plate 30 by sliding within the rails 32 and 34.

The bottom plate 24 is shown supporting a visual display unit 100, and the top plate 21 is shown supporting a visual display unit 200. The bottom plate 24 of the central portion is positioned in a horizontal plane and 25 mm above the desktop 10. The top plate 21 is also positioned in a horizontal plane. Accordingly, the bottom plate 24 and top plate 21 provide level surfaces for the visual display units 100 and 200 to sit upon. Alternatively, the visual display unit 100 may be attached to the central portion by integral brackets provided on the top, left, right, and/or bottom plates 21, 22, 23, 24. The visual display units are connected to a computer base unit (not shown in figs) beneath the desktop 10.

The two side portions 40 and 45 comprise a left side portion 40 and a right side portion 45. The left side portion 40 is positioned adjacent the left side plate 22 of the central portion, and the right side portion 45 is positioned adjacent the right side plate 23 of the central portion. Each of the side portions is associated with an extension arm 42 (only visible in Figs for the right side portion 45) and a cradle 43.

The cradle 43 associated with the left side portion 40 is attached to the left side plate 22 of the central portion, and the cradle 43 associated with the right side portion 45 is attached to the right side plate 23 of the central portion. Each extension arm 42 is pivotally connected between the associated cradle 43 and the associated side portion 40 or 45.

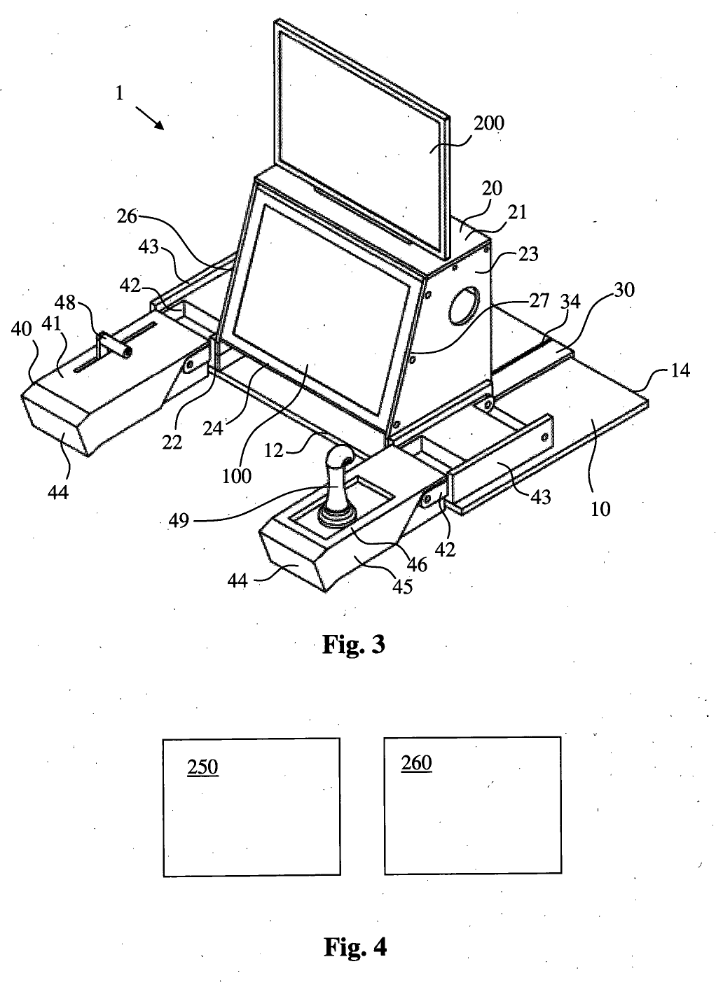

The side portions each comprise distal ends 44 (refer to FIG. 3) that are angled so that the side portions 40 and 45 come to a stable rest when the distal ends 44 contact the cradles 43 in the position shown in FIG. 1.

In the position shown in FIG. 1. the extension arms 42 and the distal ends 44 stably hold front faces 41 and 46 of the side portions flush with forward edges 26 and 27 of the side plates 22 and 23 respectively. If required, then the side portions 40 and 45 may be further secured in this position using securing means, for example retractable pins provided between the side portions and the cradles.

The left side portion 40 comprises a simulated vehicle control interface in the form of a throttle control 48 on the front face 41, and the right side portion 45 comprises a simulated vehicle control interface in the form of a stick control 49 on the front face 46. The throttle control 48 and the stick control 49 simulate the controls of an aircraft, and may be used to send commands to the computer base unit. The commands may be reflected by data that is displayed on the visual display units 100 and 200 by the computer base unit.

The side portions 40 and 45 are shown in a stowed position, being upright at around 30 degrees to the vertical, such that they take up significantly less space in the direction of sliding DS of the central portion compared to if they were laid horizontal.

A computer keyboard 70 is shown resting upon the desktop 10 in a clear area of the desktop between the base portion plate 30 and the edge 12 of the desktop. The keyboard 70 is wirelessly connected to the computer base unit, and may be used to send commands thereto. The commands may be reflected by data that is displayed on the visual display units 100 and 200 by the computer base unit.

The vehicle simulator station 1 may be used to develop or configure a flight simulator program, the keyboard 70 upon the desk being used to write or configure the flight simulator program and the throttle control 48 and stick control 49 being used to test the flight simulator program.

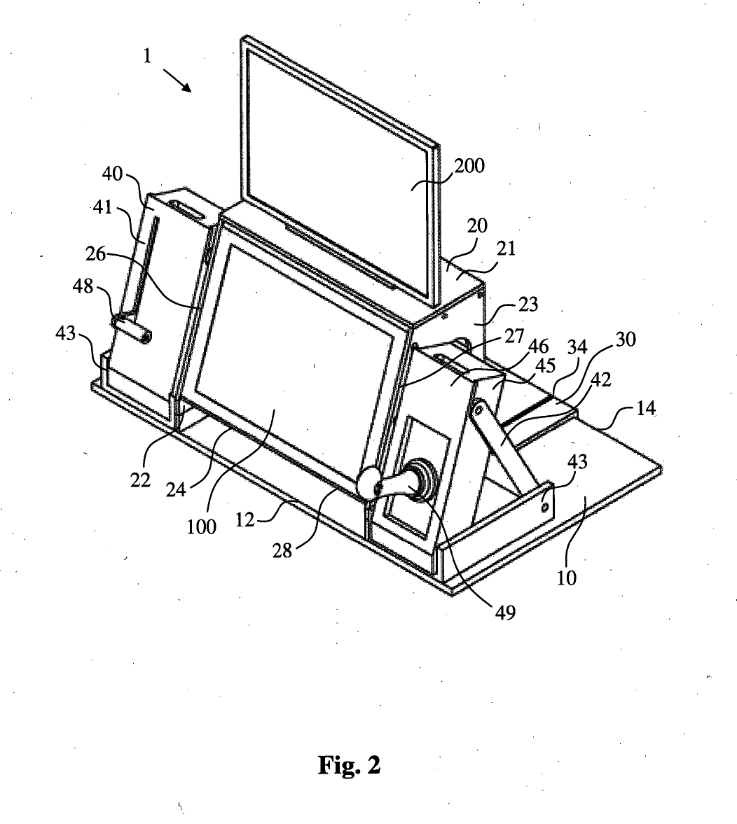

The central portion 20 is configured to slide over the base portion plate 30 within rails 32 and 34 that extend along a top surface of the base portion plate 30. The base portion plate 30 is secured upon the desktop 10 by the clamps such that the rails 32 and 34 extend in a direction perpendicular between front and rear edges 12 and 14 of the desktop. Accordingly, the central portion 20 is slidable along the rails 32 and 34 to move it towards the front edge 12 of the desktop 10 in the direction of sliding DS, as shown in the schematic diagram of FIG. 2.

Compared to the position of the central portion 20 in FIG. 1, FIG. 2 shows that the central portion 20 has been slid in the direction DS towards the edge 12 of the desktop 10. Since the bottom plate 24 of the central portion is positioned in a horizontal plane and 25 mm above the desktop 10, and the direction of sliding DS is parallel to both the horizontal plane of the bottom plate 24 and the horizontal plane of the desktop 10, the bottom plate 24 maintains a distance of 25 mm between the bottom plate 24 and the desktop 10 during the sliding of the central portion 10 towards the edge 12 of the desktop. Accordingly, the bottom plate 24 moves over the top of the keyboard 70 without impacting into it, so that the keyboard 70 is positioned beneath the bottom plate 24 when the central portion 20 is in, the position shown in FIG. 2.

Since the cradles 43 are attached to the left and right side plates 22 and 23 of the central portion 20, the cradles 43 and side portions 40 and 45 also move in the direction of sliding DS when the central portion 20 is moved in the direction of sliding DS. Accordingly, a user can more easily reach the throttle control 48 and stick control 49 when the central portion is slid towards them into the position shown in FIG. 2. Therefore, the user may choose to slide the central portion towards them into this position when they wish to test the flight simulator program, without needing to clear the area of the desktop between the edge 12 and the base portion 30, since the bottom plate 24 slides over this area whilst leaving a gap of 25 mm for anything placed within this area, such as the keyboard 70. The gap of 25 mm is clearly just for illustratory purposes, and other gap sizes may also be implemented, for example gaps greater than 25 mm. The cradles 43 could alternatively be attached to the base portion 30, rather than the left and right side plates 22 and 23, such that they would need to be slid towards the edge 12 separately from sliding the central portion 20 towards the edge 12.

The schematic diagram of FIG. 3 shows the vehicle simulator station 1 in a position wherein the left and right side portions 40 and 45 are in an extended position. This has been achieved by extending them in the direction of the sliding of the central portion towards the edge 12 of the desktop, and beyond the edge 12 of the desktop.

In particular, the transitioning of the left and right side portions 40 and 45 from the stowed position shown in FIGS. 1 and 2 to the extended position shown in FIG. 3, comprises moving the side portions from a more upright position (stowed position) in which they take up less space in the direction of the sliding of the central portion, to a more horizontal position (extended position) in which they take up more space in the direction of the sliding of the central portion.

The left and right side portions 40 and 45 may extend either side of a user (not shown in Figs), the user facing the visual display units 100 and 200, and sitting adjacent the edge 12 and between the left and right side portions 40 and 45. Extending the left and right side portions 40 and 45 to the position shown in FIG. 3 creates a more realistic simulated vehicle cockpit for the user. Specifically, the extended positions of the left and right side portions 40 and 45 place the throttle control 48 and stick control 49 in positions simulating their positions in an aircraft.

The left and right side portions 40 and 45 can be extended beyond the edge 12 of the desktop without over-balancing because they are secured to the left and right side plates 22 and 23 (or, alternatively, to the base portion 30). In an alternative embodiment, the left and right side portions 40 and 45 may not be secured to the central or base portions, but could be secured more directly to the desktop by securing the cradles 43 to the desktop 10 using an attachment means such as sucker pads on the cradles 43.

If the user wishes to return to using their keyboard 70, then they can simply move the left and right sides portions 40 and 45 back into the stowed configuration (as shown in FIG. 2), and then move the central portion 20 back towards the edge 14 of the desktop (as shown in FIG. 1) to reveal the keyboard again.

Putting the left and right side portions 40 and 45 into the stowed position shown in FIGS. 1 and 2 helps creates more space upon the desktop 10 for when the user wishes to work upon the desktop 10. The simulated vehicle control interfaces 48 and 49 are still available for the user to operate when the left and right side portions 40 and 45 are in the stowed position. The left and right side portions 40 and 45 could be extended whilst the central portion 20 was still maintained in the position shown in FIG. 1, to move the simulated vehicle control interfaces 48 and 49 closer to the user for easier access, whilst still maintaining access to the keyboard 70.

As an alternative to placing the keyboard 70 upon the desktop, the central portion 20 may provided with a retractable shelf for supporting the keyboard. The retractable shelf may be configured to extend towards the user in the direction of sliding of the central portion towards the edge of the desktop, such that the keyboard can be extended towards the user when required, further increasing flexibility.

In addition to the side portions 40 and 45, a centre control portion (not shown in Figs) that extends from the central portion 20 in the direction DS of the sliding of the central portion towards the edge of the desktop may be provided. The centre control portion comprises a central simulated vehicle control interface, for example an aircraft yoke.

The centre control portion attaches to the front edge 28 of the bottom plate 24 using a fastener, and has a first portion configured to extend beyond the edge 12 of the desktop 10, and a second portion configured to extend beneath the desktop 10 to help counterbalance the weight of the first portion. The central simulated vehicle control interface is provided on the first portion.

The schematic diagram of FIG. 4 shows two transportation boxes into which the vehicle simulator station 1 may be disassembled and stored for transport. The left and, right side portions may be disconnected from the left and right side plates of the central portion 20, and fitted into the transportation box 250 when in the extended position. The left and right side plates 22 and 23 may be connected to the bottom plate 24 with hinges, and removably connected to the top plate 21, such that when the top plate 21 is removed the left and right side plates 22 and 23 can hinge towards one another to rest upon one another and the bottom plate 24. The removed top plate 21, the bottom plate 21 with side plates 22 and 23 hinged over one another, and the base portion 30, may be stacked into the transportation box 260.

The hinges of the left side plate 22 may have a hinge axis positioned at the plane of the bottom plate 24, and the hinges of the right side plate 23 may have a hinge axis positioned above the plane of the bottom plate 24 by a distance corresponding to the thickness of the left side plate 22, so that the left and right side plates lie flat upon one another when fully hinged towards one another, with the left side plate 22 being in between the bottom plate 24 and the right side plate 24. Alternatively, the hinges of the right side plate 23 may have a hinge axis positioned at the plane of the bottom plate 24, and the hinges of the left side plate 22 may have a hinge axis positioned above the plane of the bottom plate 24 by a distance corresponding to the thickness of the right side plate 23, so that the left and right side plates lie flat upon one another when fully hinged towards one another, with the right side plate 23 being in between the bottom plate 24 and the left side plate 22.

Further embodiments falling within the scope of the appended claims will also be apparent to those skilled in the art. For example other types of vehicle cockpit could be simulated than aircraft cockpits, only one of the left and right side portions 40 and 45 may be implemented, or additional side portions adjacent one or both of the left and right side portions 40 and 45 may also be implemented.

1. A vehicle simulator station for resting upon a desktop, the vehicle simulator station comprising a central portion for sliding towards an edge of the desktop, and a side portion configured to transition from a stowed position adjacent the central portion to an extended position beyond the central portion in the direction of the sliding of the central portion towards the edge of the desktop.

2. The vehicle simulator station of claim 1, further comprising a base portion for resting upon the desktop, wherein the central portion is configured to slide over the base portion to perform the sliding of the central portion towards the edge of the desktop

3. The vehicle simulator station of claim 2, wherein the base portion comprises fixing means for fixing a position of the base portion upon the desktop.

4. The vehicle simulator station of claim 2, wherein the base portion comprises rails for the sliding of the central portion over the base portion.

5. The vehicle simulator station of claim 2, wherein the base portion supports the central portion at least 25 mm above the desktop, such that the sliding of the central portion towards the edge of the desktop can take place without impacting a keyboard positioned on the desktop between the base portion and the edge of the desktop.

6. The vehicle simulator station of claim 1, wherein the central portion comprises a platform for supporting a visual display unit.

7. The vehicle simulator station of claim 1, wherein the side portion is supported by the central portion or the base portion, such that the side portion can be slid beyond the edge of the desktop in the extended position.

8. The vehicle simulator station of claim 1, wherein the sliding of the side portion from the stowed position to the extended position comprises moving the side portion from a more upright position in which it takes up less space in the direction of the sliding of the central portion, to a more horizontal position in which it takes up more space in the direction of the sliding of the central portion.

9. The vehicle simulator station of claim 1, wherein the side portion comprises a simulated vehicle control interface.

10. The vehicle simulator station of claim 9, wherein the simulated vehicle control interface is operable to control a simulated vehicle when the side portion is in both the stowed position and the extended position.

11. The vehicle simulator station of claim 1, comprising a further side portion for sliding from a stowed position adjacent the central portion to an extended position beyond the central portion in the direction of the sliding of the central portion towards the edge of the desktop.

12. The vehicle simulator station of claim 11, wherein the further side portion comprises a further simulated vehicle control interface, wherein the simulated vehicle control interface comprises a throttle control, wherein the further simulated vehicle control interface comprises a stick control, and wherein the extended positions of the side portion and the further side portion place the throttle control and stick control in positions simulating their positions in an aircraft.

13. The vehicle simulator station of claim 1, comprising a centre control portion that extends from the central portion in the direction of the sliding of the central portion towards the edge of the desktop, the centre control portion comprising a central simulated vehicle control interface.

14. An apparatus comprising the vehicle simulator station of claim 1 and at least one transportation box, wherein the vehicle simulator station is configured to be disassembled and stored for transport in the at least one transportation box.

15. The apparatus of claim 14, wherein the central section is constructed from plate elements configured to stack upon one another for compact storage in one or more of the at least one transportation box.

16. (canceled)
